(19) United States
(12) Patent Application Publication
(10) Pub. No.: US 2026/0210170 A1
(43) Pub. Date: Jul. 23, 2026

(54) MULL ASSEMBLY AND METHOD FOR INSTALLING WINDOWS ON-SITE

(71) Applicant: PROVIA HOLDINGS, INC., Sugarcreek, OH (US)

(72) Inventors: Thomas BREWER, Sugarcreek, OH (US); Wendell MAST, Sugarcreek, OH (US)

(21) Appl. No.: 19/134,271

(22) PCT Filed: Dec. 4, 2023
(86) PCT No.: PCT/US2023/082303

§ 371 Date: May 30, 2025

Related U.S. Application Data
(60) Provisional application No. 63/429,747, filed on Dec. 2, 2022.

(51) Int. Cl. E06B 1/60

(52) U.S. Cl. CPC E06B 1/6007

(57) ABSTRACT

Provided is window mull assembly and method for connecting two or more windows at the site of installation and immediately prior to installation. The window mull can be applied to any configuration of window, including casement, awning, single hung, double hung, picture windows, and the like. The window mull assembly may include a mull mechanism having a first strip and a second strip. Each strip may include a window-mating face that attaches to a vertical profile of a corresponding window frame and a strip-mating face. The strip-mating face of each strip may engage with one another. Each strip-mating face may include a brace and an angled projection. The strips may be substantially identical but oriented in the corresponding window frame in opposite directions so that the angled projection of each strip extends in an opposite direction and may engage with one another in a hook like manner.

### CROSS-REFERENCE TO RELATED APPLICATIONS

The present application claims priority to and the benefit of U.S. Provisional Application No. 63/429,747 filed on Dec. 2, 2022, the disclosure of which is incorporated by reference in its entirety.

### TECHNICAL FIELD

The present invention relates generally to a quick mull assembly and method for installing windows and, more particularly, to a quick mull assembly and method for connecting two or more windows at the site of installation of the windows.

### BACKGROUND

Larger singular windows, although generally preferred by consumers for their maximization of natural light compared to alternative smaller singular windows, can require custom fabrication and more complex installation. Larger singular windows can also cost more due to the additional work, manpower, and coordination that the larger singular windows can require for their fabrication and installation. For instance, larger singular windows may be difficult to maneuver through a house or building for placement, may be very heavy, and may be more susceptible to breaking.

Mulling is the process of closely and securely connecting two or more smaller windows by their frames to fill a larger window opening. Mulled windows can give the general appearance of a larger singular window and provide a similar amount of natural light. Mulled windows, however, are generally connected on-site at the factory and delivered to a consumer or location for install already connected. As a result, mulled windows may encounter similar constraints in fabrication and installation as larger singular windows. For instance, mulled windows may be difficult to maneuver through a house or building for placement, may be very heavy, and may be more susceptible to breaking, thus requiring additional work, manpower, and coordination for their fabrication and installation.

A need is therefore identified for an improved assembly and method for mulling windows that achieves one or more (or all) of the following: on-site mulling and installation, faster mulling and installation, easier maneuvering of the windows, separate maneuvering of the windows, reduced costs, easier transportation requirements, smaller package to transport, reduced number of installers, and the like.

### SUMMARY

The following presents a summary of this disclosure to provide a basic understanding of some aspects. This summary is intended to neither identify key or critical elements nor define any limitations of embodiments or claims. This summary may provide a simplified overview of some aspects that may be described in greater detail in other portions of this disclosure. Furthermore, any of the described aspects may be isolated or combined with other described aspects without limitation.

Provided is window mull assembly and method for connecting two or more windows at the site of installation and immediately prior to installation. The window mull can be applied to any configuration of window, including casement, awning, single hung, double hung, picture windows, and the like. The window mull assembly may include a mull mechanism having a first strip and a second strip. Each strip may include a window-mating face that attaches to a vertical profile of a corresponding window frame and a strip-mating face. The strip-mating face of each strip may engage with one another. Each strip-mating face may include a brace and an angled projection. The strips may be substantially identical but oriented in the corresponding window frame in opposite directions so that the angled projection of each strip extends in an opposite direction and may engage with one another in a hook like manner. The mull mechanism may further include at least one clip strip, where each clip strip attaches vertically to both window frames on the exterior and interior surfaces of the window frames. The mull mechanism may further include a mullion cover that attaches horizontally to both window frames on the top of the window frames.

According to one aspect, a mulling mechanism includes a first strip configured to attach to a first frame of a first window and including a first mating projection; a second strip configured to attach to a second frame of a second window and including a second mating projection. The mating projection of the first strip is configured to engage with the mating projection of the second strip.

According to an embodiment, the first strip includes a first spine, and the second strip includes a second spine. The first and second mating projections are disposed at an angle of about 45° relative to the first and second spines, respectively.

According to an embodiment, the first and second mating projections extend in opposite directions when attached to the first and second frames of the respective first and second windows.

According to an embodiment, the first mating projection is configured to hook with the second mating projection

According to an embodiment, each of the first strip and the second strips are attachable to the corresponding first and second frames by one or more fasteners.

According to an embodiment, the one or more fasteners are screws that are insertable through the first strip or the second strip.

According to an embodiment, the mulling mechanism further includes a pair of clip strips, wherein each of the clip strips is configured to attach to both the first window and the second window and wherein a first clip strip is configured to attach to exterior sides of the first window and the second window and a second clip strip is configured to attach to interior sides of the first window and the second window.

According to an embodiment, the mulling mechanism further includes a mullion cover, wherein the mullion cover is configured to attach to both the first window and the second window at an edge of the first window and the second window that is perpendicular to the first and second clip strips.

According to an embodiment, at least one of the first and second strips, the pair of clip strips, and the mullion cover comprise plastic.

According to an embodiment, the mulling mechanism is configured to connect two windows in a side-to-side configuration.

According to an embodiment, the mulling mechanism is configured to connect two windows in a top-to-bottom configuration.

According to an embodiment, the mulling mechanism is configured be installed at the site of window installation.

According to an embodiment, the mulling mechanism further includes a seal disposed between the first frame and the second frame, wherein the seal is configured to prevent water ingress.

According to another aspect, a mulled window includes a first window comprising a first recessed mating face and a second window comprising a second recessed mating face. A first strip disposed in the first recessed mating face, and a second strip disposed in the second mating face. The first strip and the second strip are configured to interlock to secure the first window to the second window.

According to an embodiment, the first strip includes a first spine extending along at least a partial longitudinal length thereof, and the second strip includes a second spine extending along at least a partial longitudinal length thereof, wherein a first projection extends from the first spine, and wherein a second projection extends from the second spine, wherein the first projection and the first spine define a first angle, and wherein the second projection and the second spine define a second angle.

According to an embodiment, the first and second angles are between about 15 degrees and 75 degrees.

According to an embodiment, the first and second angles are equal to each other.

According to an embodiment, the first and second spines respectively include first and second braces extending therefrom.

According to an embodiment, the first brace is disposed at about a 90 degree angle relative to the first spine, and the second brace is disposed at about a 90 degree angle relative to the second spine.

According to an embodiment, the mulled window further includes a third window including a third recessed mating face and a fourth window including a fourth recessed mating face. A third strip disposed in the third recessed mating face and a fourth strip is disposed in the fourth mating face. The third and fourth strips are configured to interlock to secure the third window and the fourth window.

### DESCRIPTION OF THE DRAWINGS

Operation of the present teachings may be better understood by reference to the detailed description taken in connection with the following illustrations. These appended drawings form part of this specification, and written information in the drawings should be treated as part of this disclosure. In the drawings:

FIG. 1 is a perspective view of an embodiment of a mulled window connected by a mull mechanism in accordance with aspects disclosed herein;

FIG. 2 is a front view of an embodiment of a mulled window connected by a mull mechanism in accordance with aspects disclosed herein;

FIG. 3 is a cross-sectional view of an embodiment of a mulled window connected by a mull mechanism taken along line A-A in FIG. 2 in accordance with aspects disclosed herein;

FIG. 4 is a magnified view of an embodiment of a mulled window connected by a mull mechanism shown as detail A in FIG. 3 in accordance with aspects disclosed herein;

FIG. 5 is a magnified view of an embodiment of a mulled window connected by a mull mechanism shown as detail A in FIG. 3 in accordance with aspects disclosed herein;

FIG. 6 is a cross-sectional view of an embodiment of a mulled window connected by a mull mechanism taken along line B-B in FIG. 2 in accordance with aspects disclosed herein;

FIG. 7 is a magnified view of an embodiment of a mulled window connected by a mull mechanism shown as detail V in FIG. 6 in accordance with aspects disclosed herein;

FIG. 8 is a front view of an embodiment of a mulled window connected by a mull mechanism in accordance with aspects disclosed herein;

FIG. 9 is a cross-sectional view of an embodiment of a mulled window connected by a mull mechanism taken along line F-F in FIG. 8 in accordance with aspects disclosed herein;

FIG. 10 is a magnified view of an embodiment of a mulled window connected by a mull mechanism shown as detail H in FIG. 9 in accordance with aspects disclosed herein;

FIG. 11 is a perspective view of an embodiment of a mulled window connected by a mull mechanism in accordance with aspects disclosed herein;

FIG. 12 is a magnified view of an embodiment of a mulled window connected by a mull mechanism shown as detail J in FIG. 11 in accordance with aspects disclosed herein;

FIG. 13 is a top view of an embodiment of a mulled window connected by a mull mechanism in accordance with aspects disclosed herein;

FIG. 14 is a magnified view of an embodiment of a mulled window connected by a mull mechanism shown as detail K in FIG. 13 in accordance with aspects disclosed herein;

FIG. 15 is a magnified view of an embodiment of a mulled window connected by a mull mechanism shown as detail K in FIG. 13 in accordance with aspects disclosed herein;

FIG. 16 is a magnified view of an embodiment of a mulled window connected by a mull mechanism shown as detail K in FIG. 13 in accordance with aspects disclosed herein;

FIG. 17 is an exploded view of an embodiment of a mulled window connected by a mull mechanism in accordance with aspects disclosed herein;

FIG. 18 is a partial exploded view of an embodiment of a mulled window connected by a mull mechanism shown as detail A in FIG. 17 in accordance with aspects disclosed herein;

FIG. 19 is a top view of an embodiment of a mulled window connected by a mull mechanism in accordance with aspects disclosed herein;

FIG. 20 is a magnified view of an embodiment of a mulled window connected by a mull mechanism shown as detail B in FIG. 19 in accordance with aspects disclosed herein;

FIG. 21 is a front view of an embodiment of a mulled window connected by a mull mechanism in accordance with aspects disclosed herein;

FIG. 22 is a cross-sectional view of an embodiment of a mulled window connected by a mull mechanism taken along line T-T in FIG. 21 in accordance with aspects disclosed herein;

FIG. 23 is a cross-sectional view of an embodiment of a mulled window connected by a mull mechanism taken along line W-W in FIG. 21 in accordance with aspects disclosed herein;

FIG. 24 is a schematic of an embodiment of a method for mulling two or more windows with a mull mechanism.

FIG. 25 is an exploded view of an embodiment of a mulled quad window connected by a pair of mull mechanisms in accordance with aspects disclosed herein.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is window mull assembly and method for connecting two or more windows at the site of installation and immediately prior to installation. The window mull assembly can be applied to any configuration of window, including casement, awning, single hung, double hung, picture windows, and the like. The window mull assembly may include a mull mechanism having a first strip and a second strip. Each strip may include a window-mating face that attaches to a vertical profile of a corresponding window frame and a strip-mating face. The strip-mating face of each strip may engage with one another. Each strip-mating face may include a brace and an angled projection. The strips may be substantially identical but oriented in the corresponding window frame in opposite directions so that the angled projection of each strip extends in an opposite direction and may engage with one another in a hook like manner. The mull mechanism may further include at least one clip strip, where each clip strip attaches vertically to both window frames on the exterior and interior surfaces of the window frames. The mull mechanism may further include a mullion cover that attaches horizontally to both window frames on the top of the window frames.

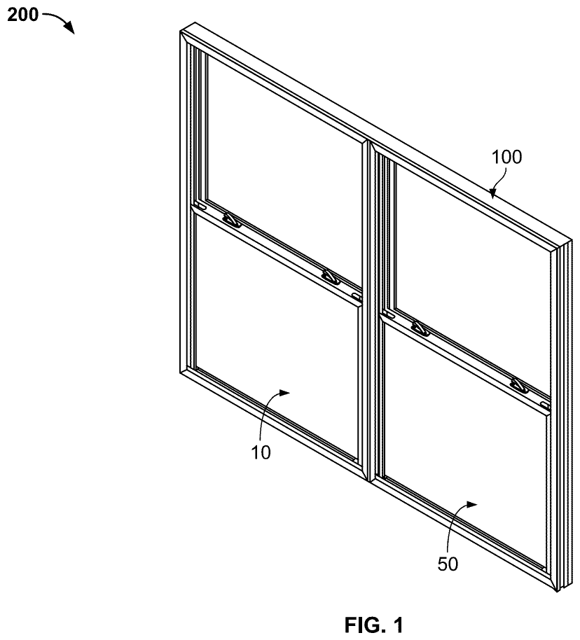

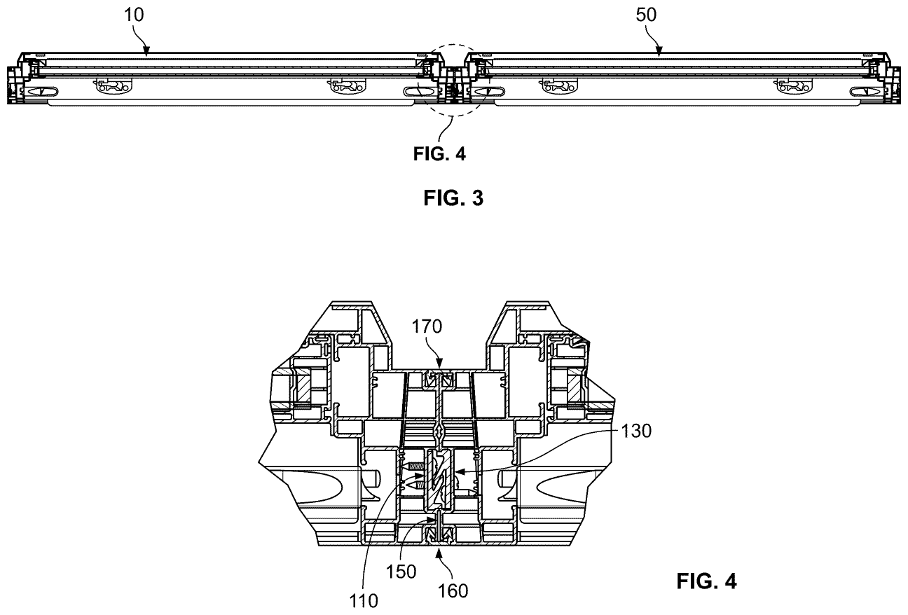

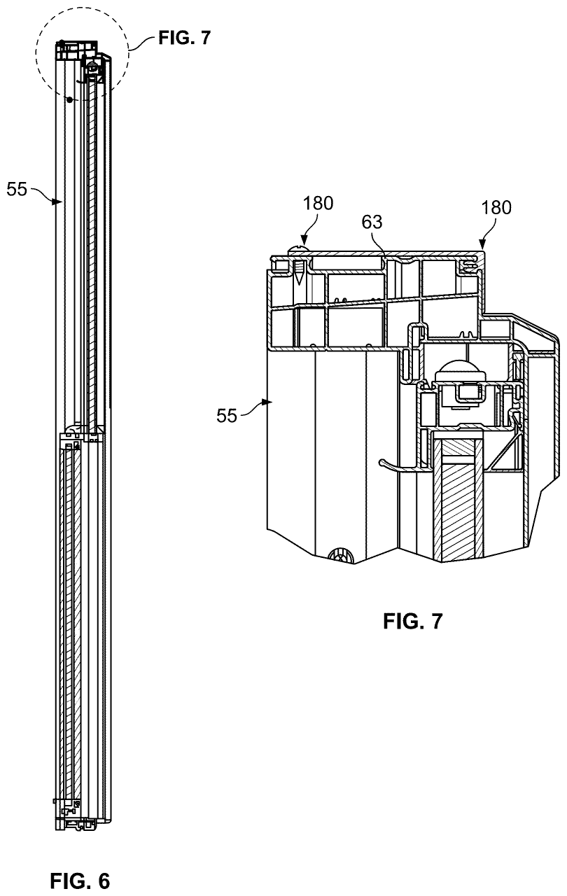

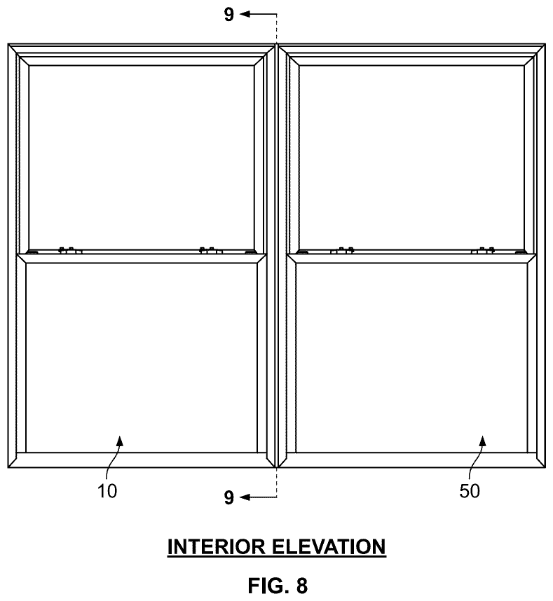

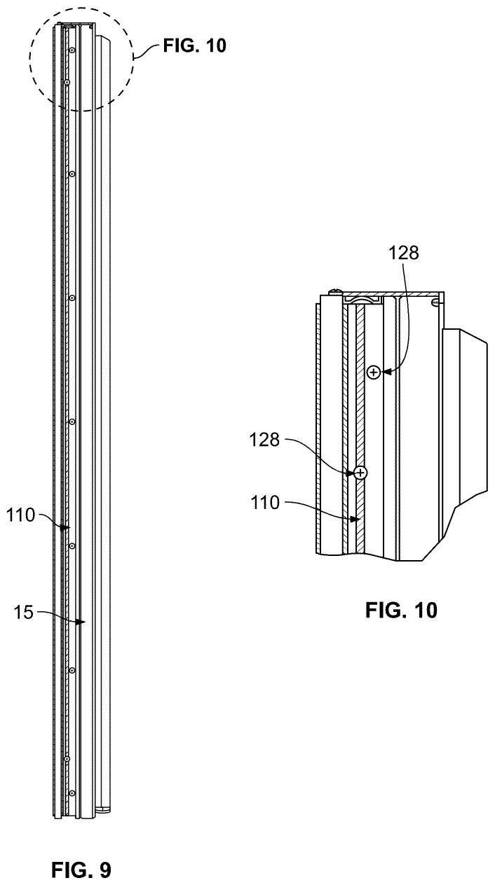

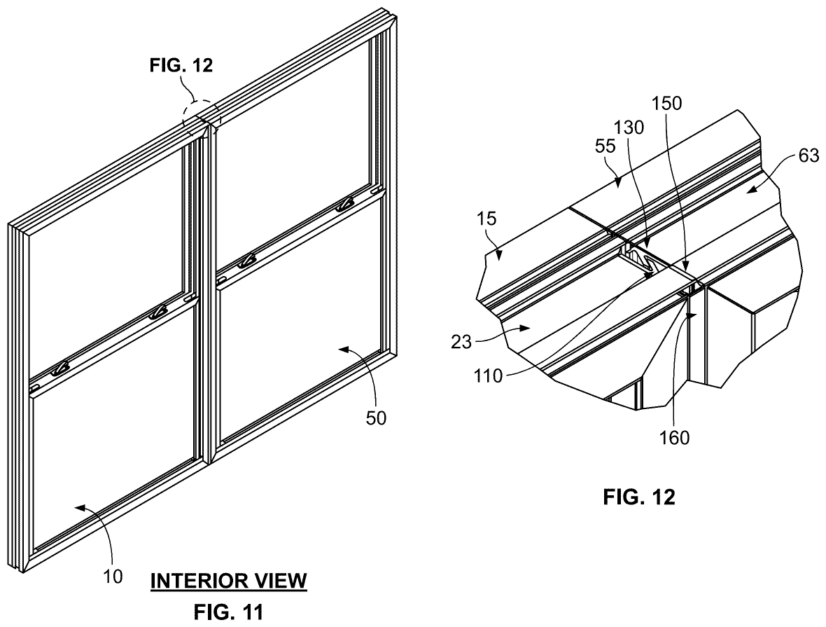

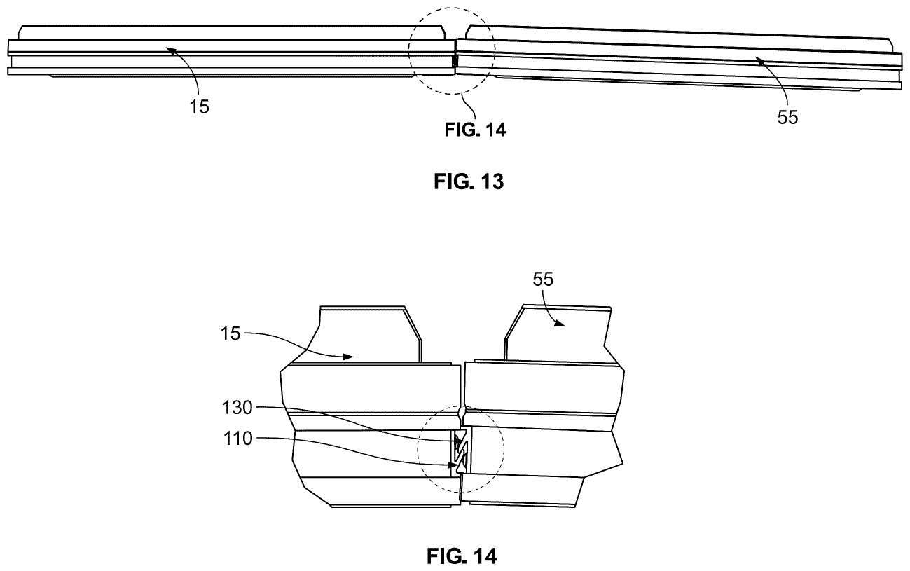

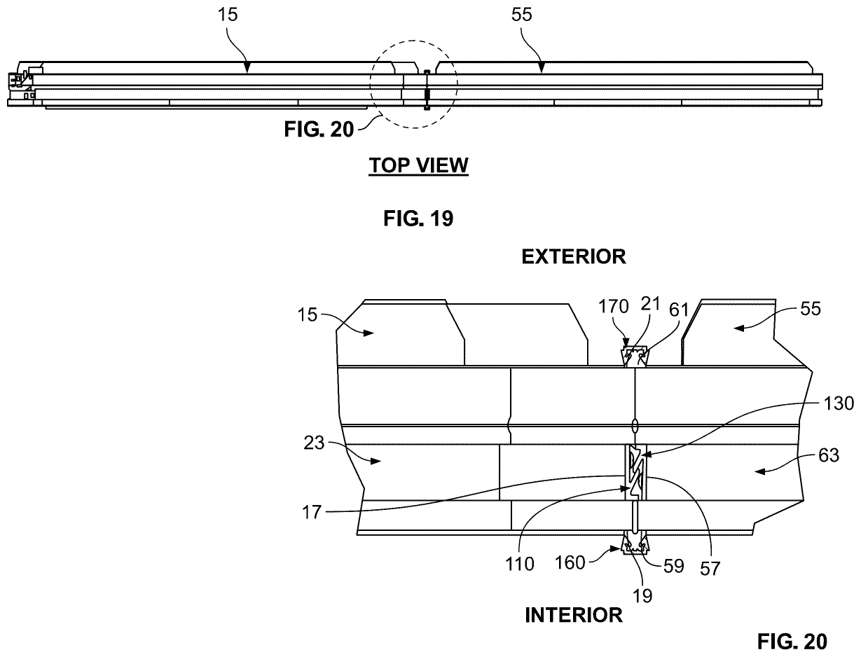

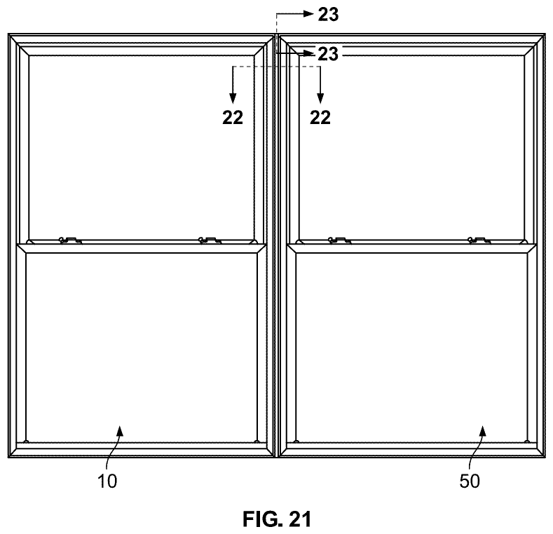

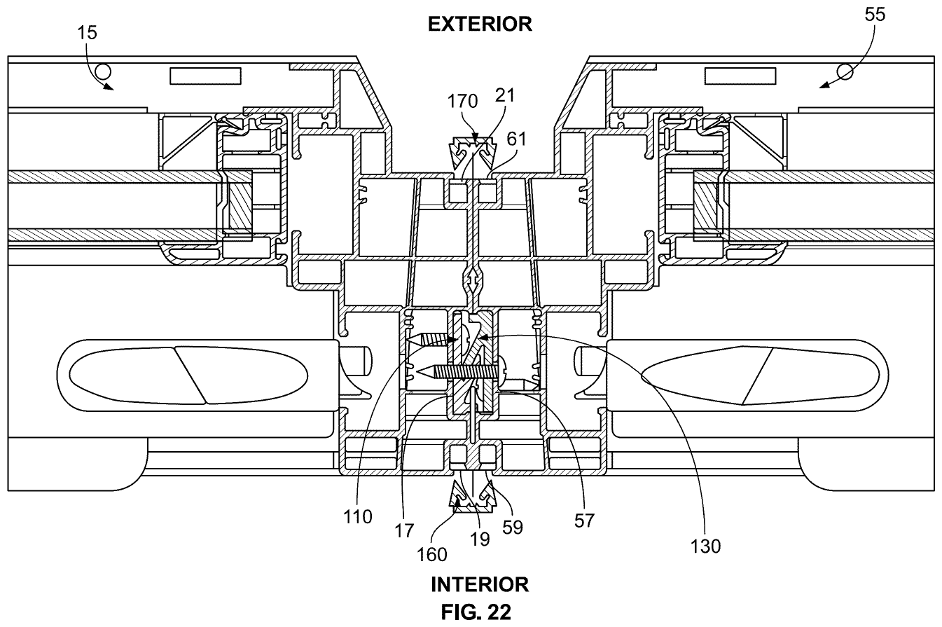

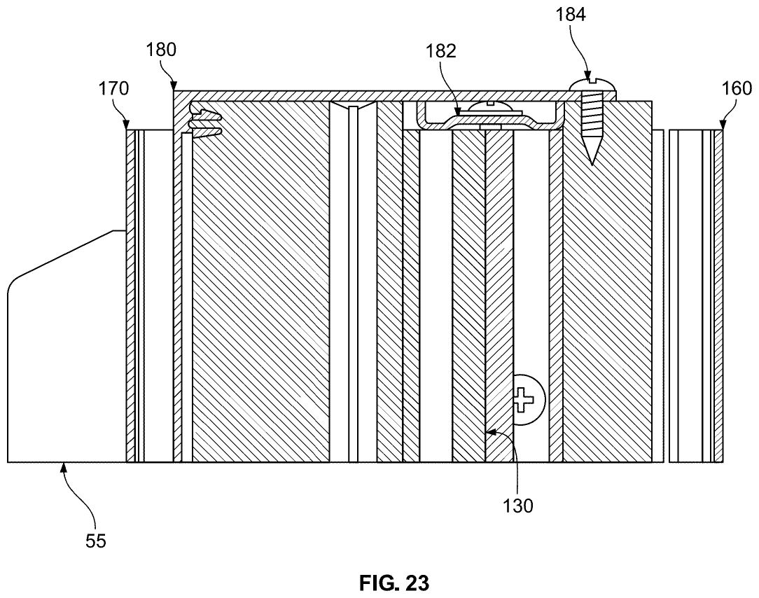

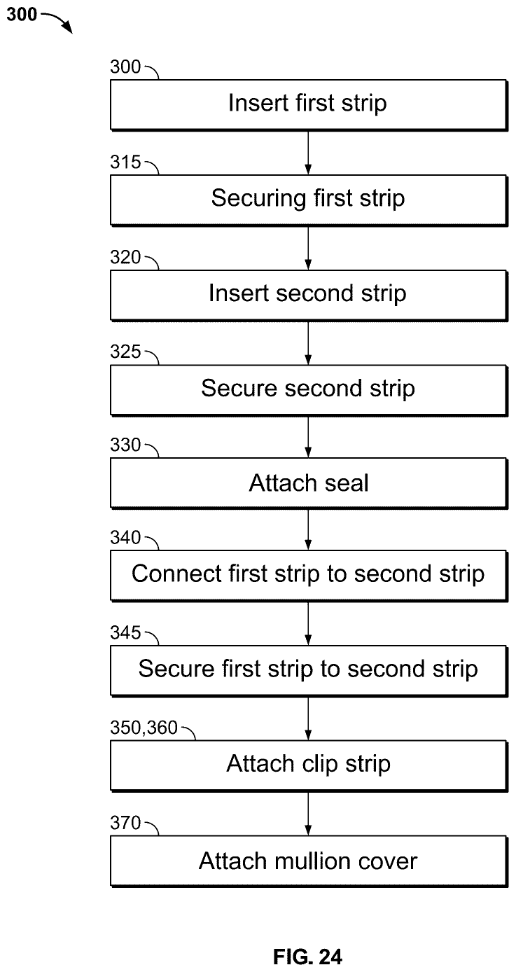

FIGS. 1-23 show embodiments of a mull mechanism 100 and mulled window 200. The mull mechanism 100 may be used to connect together two separate, smaller windows 10, 50 by their respective frames to form a mulled window 200. More than one mull mechanism 100 may be used to connect two or more windows 10, 50 together as desired. For example, two mull mechanisms may be used to connect together three separate, smaller windows by their respective frames to form a mulled window. The mulled windows 200 may give the appearance and size of a larger window. For example, the mulled window 200 may be two times, three times, etc. the size of the smaller windows (e.g., because the mulled window can be a combination of two, three, etc. smaller windows).

The mulled window 200 may be assembled at the site of installation, for example, some time prior or immediately before installation. The smaller, separate windows 10, 50 may be fabricated off-site. The smaller, separate windows 10, 50 may be transported as smaller, separate windows in a small package and may be transported or maneuvered to the installation site still as smaller, separate windows in smaller packages that require less lateral space to transport. The installation site may refer to the property at which the windows will be installed (e.g., the house or building) and may further refer to the general area where the windows will be installed (e.g., the window opening, the room, or within the general vicinity of the window opening or the room where the windows will be installed).

Previously, to achieve the aesthetic of larger windows, either larger windows or window panes were utilized or mulled windows were utilized where the connection of the windows (e.g., the mulling of the windows) was done off-site, for example, at the factory or place of manufacture. As a result, previously, larger windows and off-site mulled windows had to be transported and maneuvered in this larger state. The larger windows and off-site mulled windows therefore can require more space to transport (especially lateral space), may be difficult to maneuver for transport and to the installation site for placement, and may be more susceptible to breaking or causing tension at the mulled joints between the connected windows, and may be heavy. In fact, the weight can be so significant it can be impossible for a single person to transport such.

The mulled window 200, including at least two windows 10, 50 connected by the mull mechanism 100, may provide the general aesthetic and natural light of larger windows but with the ease of transport and maneuvering of smaller windows. Since the mulled window 200 may be transported and maneuvered as its respective components (e.g., windows 10, 50 and mull mechanism 100) and assembled at the site of installation into the larger mulled window 200, the assembly can make transporting and maneuvering the windows easier and save space during transport. The assembly may also allow installers to handle the windows on an individual basis (e.g., as separate windows 10, 50) as opposed to a fully assembled or attached unit. The assembly can reduce the overall weight and size of the windows (e.g., as separate windows 10, 50) that the installers must manage in transporting and maneuvering the windows to the site of installation. The assembly can require less installers and equipment to transport and maneuver the windows and may be less likely to break or cause tension on the components.

The mull mechanism 100 may improve window ratings. The mull mechanism 100 may provide a stronger window that can withstand higher window forces than prior art systems. The mull mechanism 100 may provide a window having a better or improved thermal rating. This configuration may prevent thermal conduction from the exterior to the interior, which may be due to a lack of metal, in an example. The prior systems are often shipped with metal plates or shipping brackets that extend horizontally across and outside the two windows, which are left on during installation. The prior art systems also often include a center metal or aluminum bracket vertical between the two windows, which is similarly left on during use. This allows the thermal conduction from outside to inside and reduces the thermal rating of the windows.

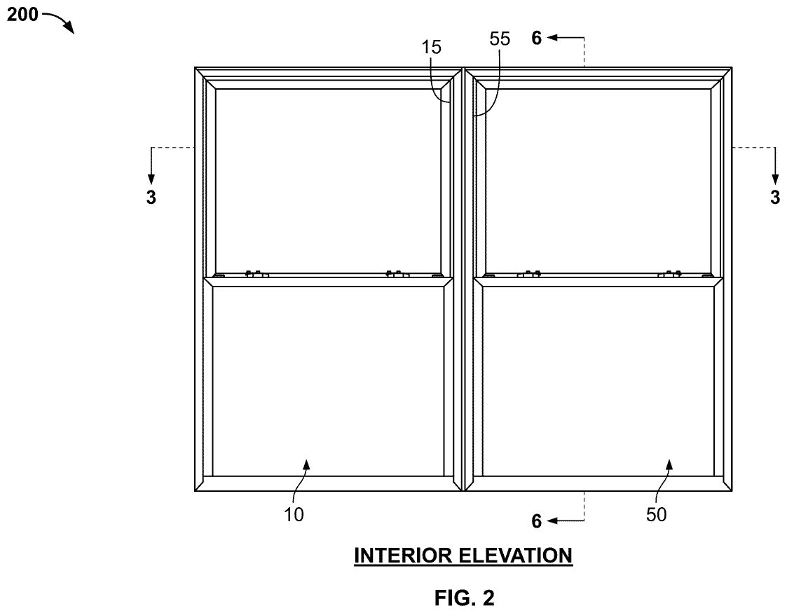

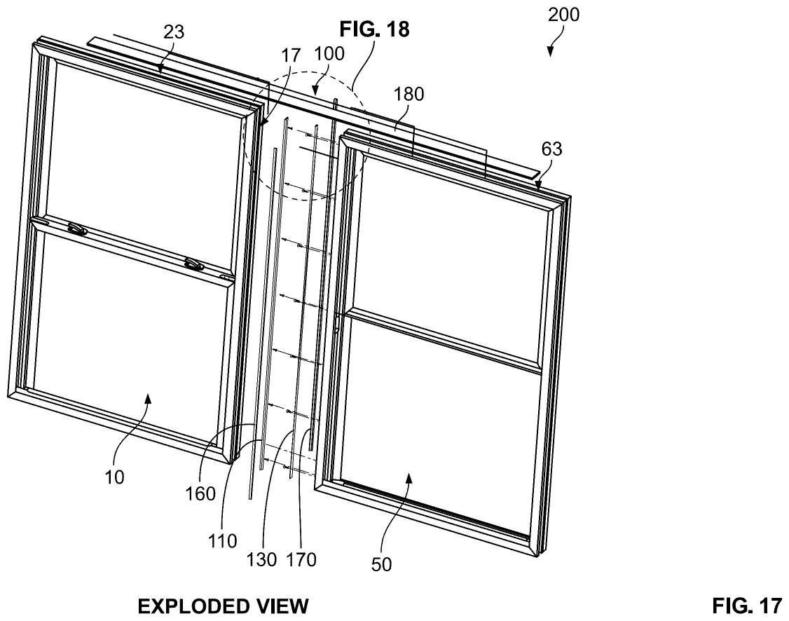

Turning to FIG. 1, shown is an embodiment of a mulled window 200, including two smaller, separate windows 10, 50 connected by a mull mechanism 100, see FIG. 17 showing an exploded view of the assembly. The mull mechanism 100 may generally fit into or mate with a frame 15, 55 (FIG. 2) of each of the two respective windows 10, 50 to connect the frames 15, 55 of the windows 10, 50 to each other to form the mulled window 200. The mull mechanism 100 may attach to both vertical and horizontal window frame profiles.

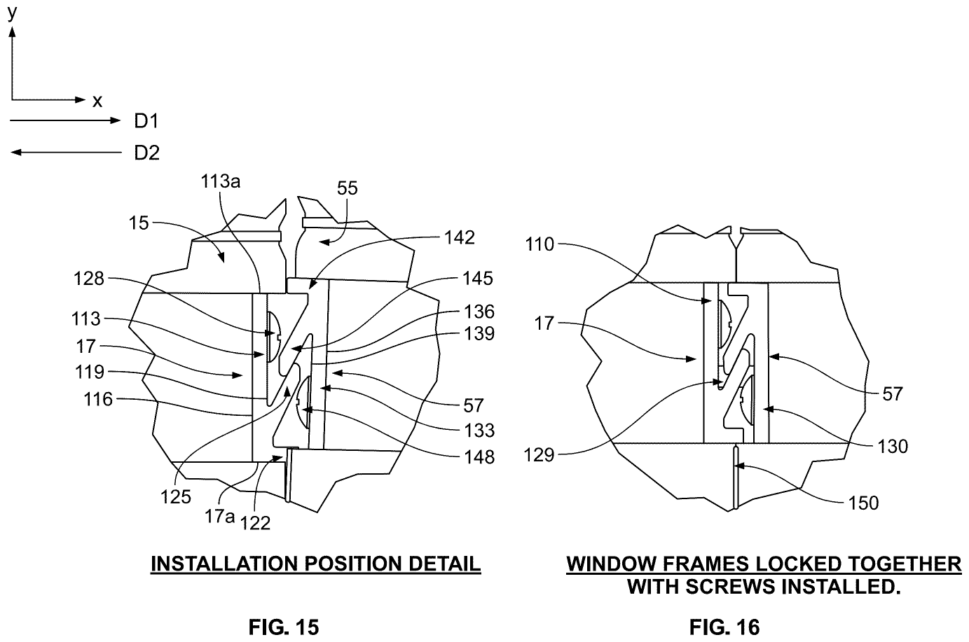

The mull mechanism 100 may comprise a first strip 110 (FIG. 4). The first strip 110 may include a spine 113 (FIG. 15). The spine 113 may have a length that generally corresponds to a length of the respective window frame (e.g., frame 15 of window 10 or frame 55 of window 50) to which the first strip 110 will attach. The spine 113 may have a length that generally corresponds to a vertical length of the respective window frame (e.g., frame 15 of window 10 or frame 55 of window 50) to which the first strip 110 will attach. Although embodiments may refer to the first strip 110 and spine 113 corresponding to and attaching to a vertical length of the respective window frame and the side-to-side attachment of windows 10, 50, it is noted that the mull mechanism 100 may also be used for the top-to bottom attachment of windows 10, 50 where the strip 110 and spine 113 correspond to and attach to a horizontal width of the respective window frame. It is noted that all aspects of the mull mechanism 100 may generally be the same in the side-to-side attachment and the top-to bottom attachment except that the vertical and horizontal profiles and components related thereto are switched. As shown in FIG. 15, the first strip 110 may further include a first mating face 116 that is configured to mate with a corresponding mating face of a first window (e.g., a window-mating face 116) and a second mating face 119 that is configured to mate with a corresponding mating face of a second strip (e.g., a strip-mating face 119). The first strip 110 may generally attach to a vertical profile of the window frame, e.g., window frame 15, 55.

Generally, the window-mating face 116 may correspond to or mate with a mating face of the window frame (e.g., frame 15 of window 10 or frame 55 of window 50) and the strip-mating face 119 may correspond to or mate with a mating face (e.g., 139) of a second strip (e.g., 130). It is noted that the described window-mating faces and mating attachments may be provided on any side of the window and window frame. It is noted that various structures and designs may be used to provide these mating attachments and that such variations are contemplated herein and do not depart from scope of this disclosure. For example, any mating face as described herein may include additional protrusions or recesses that mate with corresponding recesses or protrusions on the corresponding mating face (e.g., strip to window or strip to strip) to which the attachment of the mulled window 200 is effectuated. Such mating attachments may include, but are not limited to, snap-fit, friction fit, pressure fit, braces, brackets, tabs, pins, clips, latches, snaps, bayonet mounts or interlocks, sliding interlocks, any other female to male engagement mechanisms, fasteners, adhesives, and the like, as well as any combination of the foregoing.

The first strip 110 may further include a brace 122. The brace 122 may extend from a lengthwise edge of the spine 113 and on the strip-mating face 119 of the first strip 110. The brace 122 may extend vertically in line with the spine 113 and vertical profile of the window frame 15, 55 (e.g., when attaching the windows 10, 50 in a side-to-side orientation). The brace 122 may extend horizontally in line with the spine 113 and horizontal profile of the window frame 15, 55 (e.g. when attaching the windows 10, 50 in a top-to-bottom orientation). The brace 122 may extend generally perpendicular to the spine 113. For example, the brace 122 may extend at an angle about 90 degrees from the spine 113. For example, the brace 122 may extend at an angle between about 85 degrees to about 95 degrees from the spine 113.

The brace 122 may generally form a corner shape on one of the long edges of the spine 113. The other lengthwise edge or second long edge of the spine 113 may be flat or otherwise free from any protrusions or curves. The brace 122 and the spine 113 may form an “L-shaped” cross-section, see FIG. 15, for example (e.g., where the spine 113 forms the stem or vertical stroke of the “L” and the brace 122 forms the foot or horizontal stroke of the “L”). The brace 122 may have a smaller width than a width of the spine 113. In an embodiment, the width of the brace 122 may be ¼ to ⅕ the width of the spine 113. The brace 122 may extend the entire length of the spine 113 or the brace 122 may extend along a portion of the length of the spine 113. The brace 122 may be continuous or non-continuous as it extends along the entire length of the spine 113 or one or more portions of the spine 113.

The first strip 110 may further include a projection 125. The projection 125 may extend from the spine 113 and on the strip-mating face 119 of the first strip 110. In an embodiment, the projection 125 may extend from an area at or near the corner formed by the brace 122 and the spine 113. In an embodiment, the projection 125 may extend from an area adjacent the brace 122. The projection 125 may extend vertically in line with the spine 113, brace 122 and vertical profile of the window frame 15, 55 in side-to-side attachment of windows 10, 50 (or the horizontal profile of the window frame in top-to-bottom attachment of windows 10, 50).

The projection 125 may extend at an angle. For example, the projection 125 may extend at an angle about 45 degrees (i.e., within 5 degrees thereof) from the spine 113, e.g., relative to line extending in a direction substantially parallel with the y. For example, the projection 125 may extend at an angle between about 15 degrees to about 75 degrees (i.e., within 5 degrees thereof) from the spine 113. The projection 125 may extend toward a free edge or terminal edge of the spine 113 opposite the edge of the spine with the brace 122. The projection 125 (FIG. 15) may extend slightly past the size or width of the brace 122 (e.g., as measured in a direction substantially parallel with the x-axis in the embodiment shown). The projection 125 may extend a width before, up to, or past the width of the brace 122. In an embodiment, the width of the projection 125 may be larger than the width of the brace 122 and smaller than the width of the spine 113. The projection 125 may extend the entire length of the spine 113 or the projection 125 may extend along a portion of the length of the spine 113. The projection 125 may be continuous or non-continuous as it extends along the entire length of the spine 113 or one or more portions of the spine 113. The projection 125 may have the same or similar locations on the length of the spine 113 as the brace 122.

The window-mating face 116 of the first strip 110 may attach to the window frame (e.g., frame 15 of window 10 or frame 55 of window 50). The window-mating face 116 may be generally flat and free from protrusions. The window frame 15 of the first window 10 may include a mating face 17 (e.g., window jamb) that corresponds to or mates with the window-mating face 116 of the first strip 110. The mating face 17 of the window frame 15 may be recessed and may include a generally flat area (corresponding to the flat area of the window-mating face 116) and may include walls on each side (to form the recess and to fit around the sides of the spine 113). For example, the walls of the recessed mating face 17 may contact the brace 122 and the free end or terminal end 113a of the spine 113. The walls (e.g., wall 17a in FIG. 15) of the recessed mating face 17 may be just shorter than the width of the brace 122 (e.g., as measured in a direction substantially parallel with the x-axis in the embodiment shown). In an embodiment, the brace 122 may extend far enough to contact both the frame 15 of the first window 10 as well as a portion of the frame 55 of the second window 50.

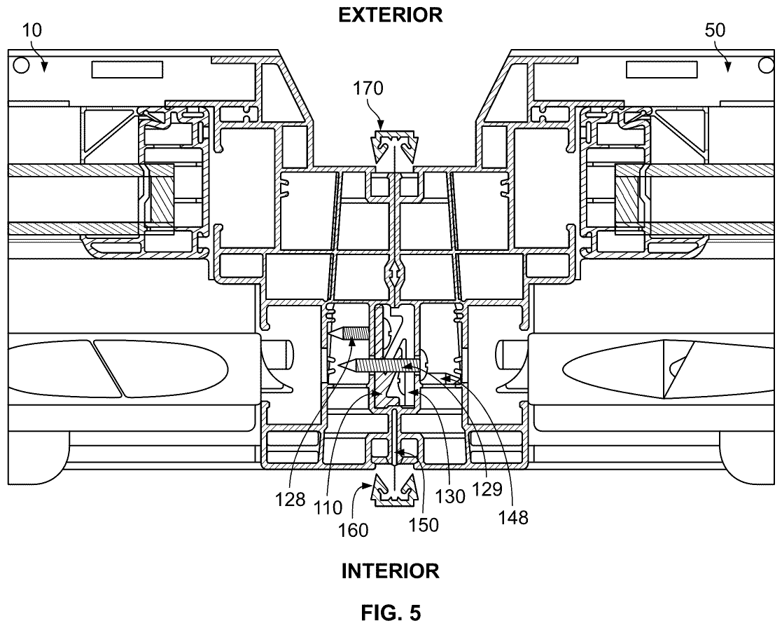

The window-mating face 116, including the spine 113 and edges thereof may fit snugly within the recessed mating face 17 of the window frame 15. In an example, the spine 113 may be configured to receive fasteners, such as screws 128 from the strip-mating face 119, through the spine 113 and the window-mating face 116 and into the recessed mating face 17 of the window frame 15, see FIG. 5, for example. The spine 113 may include apertures sized and shaped to receive the threaded end of the screws 128. The apertures may include a tapered portion allowing the screws 128 to be counter-sunk and in some embodiments, the apertures may be reinforced. The apertures may be located towards the free end or terminal end side 113a (FIG. 15) of the spine 113. A portion of the apertures and/or screws 128 may be disposed below a part of the protrusion 125 (e.g., in a height direction parallel with the y-axis in the embodiment shown) or the apertures and/or screws 128 may be positioned so that either or both are not disposed below a part of the protrusion 125 (e.g., in a height direction parallel with the y-axis in the embodiment shown). When attached to the first strip 110, the screw 128 may not be visible. The mull mechanism 100 itself may be all or mostly concealed when attached to the respective windows 10, 50 and the strips 110, 130 to each other. The number of screws 128 used to secure the first strip 110 to the window frame 15 may vary based on the size of the window frames and the corresponding length of the first strip 110. In an example, the screws 128 may be placed every 1-7 inches. It is contemplated that the number of screws 128 may be fixed in other embodiments.

In an embodiment, screws 129 may also be used to insert through the window frame 15, through the recessed mating face 17 of the window frame 17, through the spine 113 of the first strip 110 and into and through the second strip 130, see FIGS. 5, 16, and 18, for example.

Although fasteners and screws 128, 129 are herein shown and described, it is noted that the first strip 110 may be attached to the window frame 15 by other mating attachments. Such mating attachments may include, but are not limited to, snap-fit, friction fit, pressure fit, braces, brackets, tabs, pins, clips, latches, snaps, bayonet mounts or interlocks, sliding interlocks, any other female to male engagement mechanisms, fasteners, adhesives, and the like, as well as any combination of the foregoing.

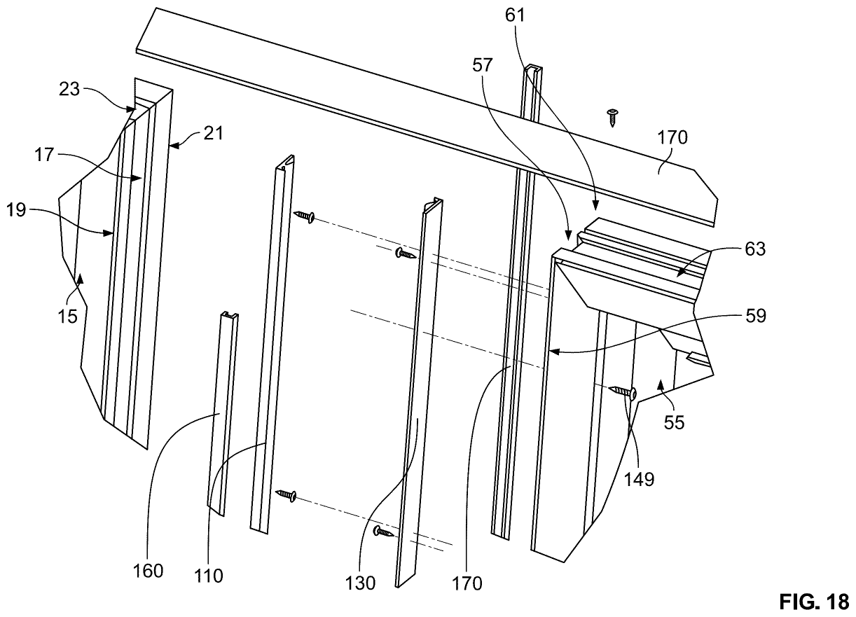

Turning to FIG. 18, for example, the mull mechanism 100 may further comprise a second strip 130. The first strip 110 and second strip 130 may have an identical structure, a substantially identical structure, a mirrored structure, a reversed mirrored structure, and the like. It is noted that the first strip 110 and the second strip 130 may also have different structures. In an example, the first strip 110 and second strip 130 may be may be generally identical, but may be positioned in the window frames 10, 50 in opposite directions. The brace 122 of the first strip 110 for example, may be positioned towards the exterior of the window 10 and the brace 142 of the second strip 130 may be positioned towards the interior of the window 50. Each projection 125, 145 of the corresponding strip 110, 130 (extending in opposite directions) may engage with one another in a hook like manner, see FIGS. 15-16, for example.

The second strip 130 may include a spine 133. The spine 133 may have a length that generally corresponds to a length of the respective window frame (e.g., frame 15 of window 10 or frame 55 of window 50) to which the second strip 130 will attach. The spine 133 may have a length that generally corresponds to a vertical length of the respective window frame (e.g., frame 15 of window 10 or frame 55 of window 50) to which the second strip 130 will attach. Although embodiments may refer to the second strip 130 and spine 133 corresponding to and attaching to a vertical length of the respective window frame and the side-to-side attachment of windows 10, 50, it is noted that the mull mechanism 100 may also be used for the top-to bottom attachment of windows 10, 50 where the strip 130 and spine 133 correspond to and attach to a horizontal width of the respective window frame. It is noted that all aspects of the mull mechanism 100 may generally be the same in the side-to-side attachment and the top-to bottom attachment except that the vertical and horizontal profiles and components related thereto are switched. The second strip 130 may further include a first mating face 136 that is configured to mate with a corresponding mating face of a first window (e.g., a window-mating face 136) and a second mating face 139 that is configured to mate with a corresponding mating face of the first strip (e.g., a strip-mating face 119 thereof). The second strip 130 may generally attach to a vertical profile of the window frame, e.g., window frame 15, 55.

Generally, the window-mating face 136 may correspond to or mate with a mating face of the window frame (e.g., frame 15 of window 10 or frame 55 of window 50) and the strip-mating face 139 may correspond to or mate with the strip-mating face 119 of the first strip 110. It is noted that the described window-mating faces and mating attachments may be provided on any side of the window and window frame. It is noted that various structures and designs may be used to provide these mating attachments and that such variations are contemplated herein and do not depart from scope of this disclosure. For example, any mating face as described herein may include additional protrusions or recesses that mate with corresponding recesses or protrusions on the corresponding mating face (e.g., strip to window or strip to strip) to which the attachment of the mulled window 200 is effectuated. Such mating attachments may include, but are not limited to, snap-fit, friction fit, pressure fit, braces, brackets, tabs, pins, clips, latches, snaps, bayonet mounts or interlocks, sliding interlocks, any other female to male engagement mechanisms, fasteners, adhesives, and the like, as well as any combination of the foregoing.

The second strip 130 may further include a brace 142. The brace 142 may extend from a lengthwise edge of the spine 133 and on the strip-mating face 139 of the second strip 130. The brace 142 may extend vertically in line with the spine 133 and vertical profile of the window frame 15, 55 (e.g., when attaching the windows 10, 50 in a side-to-side orientation). The brace 142 may extend horizontally in line with the spine 133 and horizontal profile of the window frame 15, 55 (e.g. when attaching the windows 10, 50 in a top-to-bottom orientation). The brace 142 may extend generally perpendicular to the spine 133. For example, the brace 142 may extend at an angle about 90 degrees (i.e., within 5 degrees thereof) from the spine 133. For example, the brace 142 may extend at an angle between about 85 degrees to about 95 degrees (i.e., within 5 degrees thereof) from the spine 133.

The brace 142 may generally form a corner shape on one of the long edges of the spine 133. The other lengthwise edge or second long edge of the spine 133 may be flat or otherwise free from any protrusions or curves. The brace 142 and the spine 133 may form an “L-shaped” cross-section, see FIG. 15, for example (e.g., where the spine 133 forms the stem or vertical stroke of the “L” and the brace 142 forms the foot or horizontal stroke of the “L”). The brace 142 may have a smaller width than a width of the spine 133. In an embodiment, the width of the brace 142 may be ¼ to ⅕ the width of the spine 133. The brace 142 may extend the entire length of the spine 133 or the brace 142 may extend along a portion of the length of the spine 133. The brace 142 may be continuous or non-continuous as it extends along the entire length of the spine 133 or one or more portions of the spine 133.

The second strip 130 may further include a projection 145. The projection 145 may extend from the spine 133 and on the strip-mating face 139 of the second strip 130. In an embodiment, the projection 145 may extend from an area at or near the corner formed by the brace 142 and the spine 133. In an embodiment, the projection 145 may extend from an area adjacent the brace 142. The projection 145 may extend vertically in line with the spine 133, brace 142 and vertical profile of the window frame 15, 55 in side-to-side attachment of windows 10, 50 (or the horizontal profile of the window frame in top-to-bottom attachment of windows 10, 50).

The projection 145 may extend at an angle. For example, the projection 145 may extend at an angle about 45 degrees (i.e., within 5 degrees thereof) from the spine 133. For example, the projection 145 may extend at an angle between about 15 degrees to about 75 degrees (i.e., within 5 degrees thereof) from the spine 133. The projection 145 may extend toward a free edge or terminal edge of the spine 133 opposite the edge of the spine with the brace 142. The projection 145 (FIG. 15) may extend slightly past the size or width of the brace 142 (e.g., as measured in a direction D2 substantially parallel with the x-axis in the embodiment shown). The projection 145 may extend a width before, up to, or past the width of the brace 142 (e.g., as measured in a direction D2 substantially parallel with the x-axis in the embodiment shown). In an embodiment, the width of the projection 145 may be larger than the width of the brace 142 and smaller than the width of the spine 133. The projection 145 may extend the entire length of the spine 133 or the projection 145 may extend along a portion of the length of the spine 133. The projection 145 may be continuous or non-continuous as it extends along the entire length of the spine 133 or one or more portions of the spine 133. The projection 145 may have the same or similar locations on the length of the spine 133 as the brace 142.

The first or window-mating face 136 of the second strip 130 may attach to the window frame (e.g., frame 15 of window 10 or frame 55 of window 50). The window-mating face 136 may be generally flat and free from protrusions. The window frame 55 of the second window 50 may include a mating face 57 (e.g., window jamb) that corresponds to or mates with the window-mating face 136 of the second strip 130. The mating face 57 of the window frame 55 may be recessed and may include a generally flat area (corresponding to the flat area of the window-mating face 136) and may include walls on each side (to form the recess and to fit around the sides of the spine 133). For example, the walls of the recessed mating face 57 may contact the brace 142 and the free end or terminal end of the spine 133. The walls of the recessed mating face 57 may be just shorter than the width of the brace 142. In an embodiment, the brace 142 may extend far enough to contact both the frame 55 of the second window 50 as well as a portion of the frame 15 of the first window 10.

The window-mating face 136, including the spine 133 and edges thereof may fit snugly within the recessed mating face 57 of the window frame 55. In an example, the spine 133 may be configured to receive fasteners, such as screws 148 from the strip-mating face 139, through the spine 133 and the window-mating face 136 and into the recessed mating face 57 of the window frame 55, see FIG. 5, for example. The spine 133 may include apertures sized and shaped to receive the threaded end of the screws 148. The apertures may include a tapered portion allowing the screws 148 to be counter-sunk. The apertures may be located towards the free end or terminal end side of the spine 133. A portion of the apertures and/or screws 148 may be disposed below a part of the protrusion 145 (e.g., in a height direction parallel with the y-axis in the embodiment shown) or the apertures and/or screws 148 may be positioned so that either or both are not disposed below a part of the protrusion 145 (e.g., in a height direction parallel with the y-axis in the embodiment shown). When attached to the second strip 130, the screw 148 may not be visible. The mulling mechanism 100 itself may be all or mostly concealed when attached to the respective windows 10, 50 and the strips 110, 130 to each other. The number of screws 148 used to secure the second strip 130 to the window frame 55 may vary based on the size of the window frames and the corresponding length of the second strip 130. It is contemplated that the number of screws 148 may be fixed in other embodiments. In an example, the screws 148 may be placed every 1-7 inches.

In an embodiment, screws 129 may also be used to insert through the window frame 55, through the recessed mating face 57 of the window frame 57, through the spine 133 of the second strip 130 and into and through the first strip 110, see FIGS. 5, 16, and 18, for example.

Although fasteners and screws 148, 129 are herein shown and described, it is noted that the second strip 130 may be attached to the window frame 55 by other mating attachments. Such mating attachments may include, but are not limited to, snap-fit, friction fit, pressure fit, braces, brackets, tabs, pins, clips, latches, snaps, bayonet mounts or interlocks, sliding interlocks, any other female to male engagement mechanisms, fasteners, adhesives, and the like, as well as any combination of the foregoing.

The mull mechanism 100 may further include a seal 150 (FIGS. 5, 16). The seal 150 may provide a seal that prevents the ingress of water and may provide further connection of the two windows 10, 50 at the mull joint. In an example, seal 150 may be a pressure sensitive adhesive. The seal 150 may be placed between the windows 10, 50 and adjacent the strips 110, 130, see FIG. 16, for example. The seal 150, like the first and second strips 110, 130 may be hidden or not visible as a mulled window 200 once the first 10 and the second 50 window are connected to each other and the rest of the mull mechanism 100 (e.g. clip strips and mullion covers) connected.

The mull mechanism 100 may further include at least one clip strip 160, 170 (FIG. 17). The clip strip 160, 170 may provide a seal that prevents the ingress of water and may provide further connection of the two windows 10, 50 at the mull joint. The clip strip 160, 170 may reduce the amount of caulking needed for installation and sealing of the mulled window 200 at the mull joint and may provide more consistent sealing of the mulled window 200. In an embodiment, a first clip strip 160 may be applied to an interior of the mulled window joint and a second clip strip 170 may be applied to an exterior of the mulled window joint. The clip strips 160, 170 may attach vertically to the mulled window joint such that the first clip strip 160 may attach to mating portion 19 (FIG. 18) of first window 10 and mating portion 59 of second window 50 and a second clip strip 170 may attach to mating portion 21 of first window 10 and mating portion 61 of second window 50 (e.g., when attaching the windows 10, 50 in a side-to-side orientation). When attaching the windows 10, 50 in a top-to-bottom orientation, it is noted that the clip strips 160, 170 may attach horizontally to the mulled window joint. Each clip strip 160, 170 may include two arms with a tapered protrusion that allows insertion into a corresponding mating face of the window frames 15, 55, but that prevents the removal of the clip strips due to the tapered protrusion that acts as a stop point.

The mull mechanism 100 may further include a mullion cover 180 (FIG. 17). The mullion cover 180 may provide a seal that prevents the ingress of water and may provide further connection of the two windows 10, 50 at the mull joint. The clip strip 160, 170 may reduce the amount of caulking needed for installation and sealing of the mulled window 200 at the mull joint and may provide more consistent sealing of the mulled window 200. In an embodiment, the mullion cover 180 may be applied to a top edge (or other edge) of the mulled window, perpendicular to the mulled window joint. The mullion cover 180 may be horizontally aligned with the top surface of the mulled window 200 to contact corresponding mating portion 23 of the first window 10 and mating portion 63 of the second window 50 (e.g., when attaching the windows 10, 50 in a side-to-side orientation or when the mulled window joint is related to the vertical profile of the windows 10, 50). When attaching the windows 10, 50 in a top-to-bottom orientation or when the mulled window joint is related to the horizontal profile of the windows 10, 50, the mullion cover 180 may be vertically aligned with a surface of the mulled window 200. In a top-to-bottom orientation, an embodiment may also omit an equivalent vertical mullion cover 180, e.g., for instance, but not limited to, if water or rain accumulation may not be a factor at this joint due to it being vertical. The mullion cover 180 may further include a shipping strap 182 and one or more fasteners (e.g., screw 184) to secure and attach the mullion cover 180 to the window frames 15, 55. In such embodiments, the shipping strap 182 and the fasteners may be utilized to secure the mullion cover 180 to the window frames 15, 55 when a mulled window 200 is shipped to an installation site, for example, for a window that has been mulled in an in-house setting (e.g., at a factory, distribution center, service center, or retailer, etc.) instead of at the installation site. In some embodiments, the mullion cover 180 may not include the shipping strap 182 and/or the fasteners, e.g., when one or more windows are mulled in the field to form the mulled window 200. The mullion cover 180 may include a corner edge that extends over to a side surface of the window frame 15, 5 e.g., on the exterior side of the mulled window 200. The corner edge may contact the corresponding clip strip 170 on that side. The opposite edge of the mullion cover 180 may be a free edge that terminates on the top surface of the window frames 15, 55. One or more fasteners 184 may secure the mullion cover 180 to the window frame 55 at or near the free edge on the top surface.

In an example, as shown in FIG. 17, the mullion cover 180 can have different configurations depending on the configuration of the window 10, 50. For example, the window 10, 50 may include a nail fin (used to nail the window 10, 50 to the casing). If the window 10, 50 has the nail fin, a mullion cover 180 adapted to a configuration that will fit with the nail fin may be used. It is noted that the mullion cover 180 can be adjusted to fit any configuration of window 10, 50, e.g., windows 10, 50 including a nail fin or including any other configuration. In some embodiments,

[symbol]

A method 300 for installing the mull mechanism 100 to at least two windows 10, 50 to form a mulled window 200 may include one of more of the following steps: step 310, inserting of a first strip 110 into a frame 15 of the first window 10, wherein a window-mating face 116 of the first strip 110 mates with or connects to a corresponding mating portion 17 of the frame 15; step 315, optionally inserting one or more fasteners (e.g., screw 128) from a strip-mating face 119 of the first strip 110 and into the window frame 15, (e.g., at the corresponding mating portion 17 of the window frame 15); step 320, inserting of a second strip 130 into a frame 55 of the first window 50, wherein a window-mating face 136 of the second strip 130 mates with or connects to a corresponding mating portion 57 of the frame 55; step 325 optionally inserting one or more fasteners (e.g., screw 148) from a strip-mating face 139 of the second strip 130 and into the window frame 55, (e.g., at the corresponding mating portion 57 of the window frame 55); step 330, attaching a seal 150 to one or more of portions of the window frames 15, 55 that will be mulled together; step 340, orienting the windows 10, 50 towards each other and attaching or connecting the first strip 110 to the second strip 130 so that the first window 10 is connected to the second window 50 (e.g., by mating or connecting the strip-mating faces 119, 139 of each strip 110, 130 by mating or connecting the projections 125, 145); step 345, optionally inserting one or more fasteners (e.g., screws 129) from the window frame 15, 55, through the window-mating faces 116, 136 of a strip 110, 130, through the strip 110, 130, and into and through the opposite strip 130, 110 through the strip-mating face 139, 119 and optionally into the mating face 57, 17 of the window frame 55, 15.

The method 300 may further include: step 350, 360 attaching one or more clip strips 160, 170 vertically to the mulled window joint such that a first clip strip 160 may attach to an interior side of the mulled window joint to mating portion 19 of first window 10 and mating portion 59 of second window 50 and a second clip strip 170 may attach to an exterior side of the mulled window joint to mating portion 21 of first window 10 and mating portion 61 of second window 50. It is noted that the method 300 may further include: step 350, 360 attaching one or more clip strips 160, 170 horizontally to the mulled window joint in top-to-bottom orientations or where the mulled window joint is on the width profile of respective windows.

The method 300 may further include: 370 attaching a mullion cover 180 horizontally to a top surface of the mulled window 200 to contact corresponding mating portion 23 of the first window 10 and mating portion 63 of the second window 50. It is noted that the method 300 may further include: 370 attaching a mullion cover 180 vertically to a side surface of the mulled window 200 in top-to-bottom orientations or where the mulled window joint is on the width profile of respective windows. In a top-to-bottom orientation, an embodiment may also omit an equivalent vertical mullion cover 180, e.g., for instance, but not limited to, if water or rain accumulation may not be a factor at this joint due to it being vertical.

It is noted that the steps may not necessarily be carried out in the listed order, that the optional steps may be required steps, and that steps not indicated as optional may be optionally included. It is noted that the method may include additional steps.

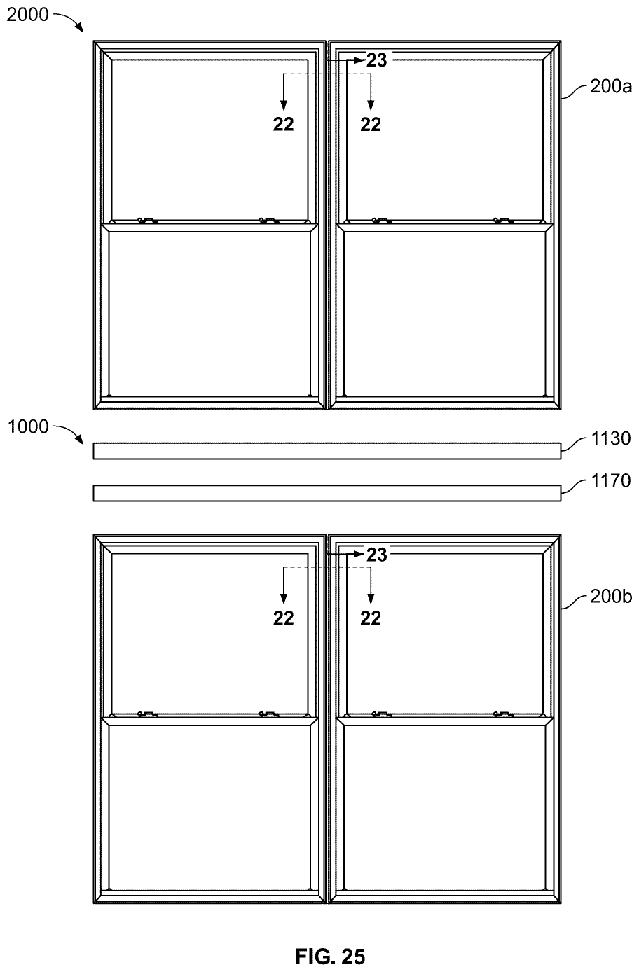

In some embodiments, a plurality of mull mechanisms may be utilized to assemble more than two windows. For instance, referring to FIG. 25, a quad mulled window 2000 (comprising a pair of mulled windows (e.g., 200a and 200b) may be formed with an additional mull mechanism 1000 (e.g., comprising horizontal first and second strips 1130, 1170) disposed therebetween. In such embodiments, the first and second strips 1130, 1170 may have similar features to the first and second strips 130, 170 discussed above. In such embodiments, a tape (e.g., a butyl tape) may be disposed between adjoining nail fins of the pair of mulled fins, e.g., where they are joined to provide for a seal therebetween.

The mull mechanism 100 may be made of a desired material, including without limitation, metals such as aluminum, plastics, rubber, or a combination of the foregoing. Further still, the strips of the mull mechanism 100 may be monolithically formed with the frame of the windows. The components of the mull mechanism may be formed in any appropriate matter, such as through 3-D printing, extruding, casting, molding or the like.

It is noted that the mull mechanism 100 can be applied to any configuration of window, including casement, awning, single hung, double hung, picture windows, and the like. It is noted that the mull mechanism 100 may be a vertical mull attaching windows in a side-to-side or horizontal configuration by the window's vertical profile or length edges of the windows, or the mull mechanism 100 may be adapted to be a horizontal mull attaching windows in a top-to-bottom or vertical configuration by the window's horizontal profile or width edges of the windows.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1. A mulling mechanism comprising:
a first strip configured to attach to a first frame of a first window and including a first mating projection; and
a second strip configured to attach to a second frame of a second window and including a second mating projection;
wherein the first and second strips are identical and the mating projection of the first strip is configured to engage with the mating projection of the second strip.

2. The mulling mechanism of claim 1, wherein the first strip comprises a first spine, and the second strip comprises a second spine, wherein the first and second mating projections are disposed at an angle of about 45° relative to the first and second spines, respectively.

3. The mulling mechanism of claim 1, wherein the first and second mating projections extend in opposite directions when attached to the first and second frames of the respective first and second windows.

4. The mulling mechanism of claim 1, wherein the first mating projection is configured to hook with the second mating projection.

5. The mulling mechanism of claim 1, wherein each of the first strip and the second strips are attachable to the corresponding first and second frames by one or more fasteners.

6. The mulling mechanism of claim 5, wherein the one or more fasteners are screws that are insertable through the first strip or the second strip.

7. The mulling mechanism of claim 1, further including a pair of clip strips, wherein each of the clip strips is configured to attach to both the first window and the second window and wherein a first clip strip is configured to attach to exterior sides of the first window and the second window and a second clip strip is configured to attach to interior sides of the first window and the second window.

8. The mulling mechanism of claim 7, further including a mullion cover, wherein the mullion cover is configured to attach to both the first window and the second window at an edge of the first window and the second window that is perpendicular to the first and second clip strips.

9. The mulling mechanism of claim 8, wherein at least one of the first and second strips, the pair of clip strips, and the mullion cover comprise plastic and are free of metal.

10. The mulling mechanism of claim 1, wherein the mulling mechanism is configured to connect two windows in a side-to-side configuration.

11. The mulling mechanism of claim 1, wherein the mulling mechanism is configured to connect two windows in a top-to-bottom configuration.

12. The mulling mechanism of claim 1, wherein the mulling mechanism is configured be installed at a site of window installation.

13. The mulling mechanism of claim 1 further comprising:
a seal disposed between the first frame and the second frame, wherein the seal is configured to prevent water ingress.

14. A mulled window comprising:
a first window comprising a first recessed mating face;
a second window comprising a second recessed mating face;
a first strip disposed in the first recessed mating face; and
a second strip disposed in the second mating face;
wherein the first strip and the second strip are identical and are configured to interlock to secure the first window to the second window.

15. The mulled window of claim 14, wherein the first strip comprises a first spine extending along at least a partial longitudinal length thereof, and wherein the second strip comprises a second spine extending along at least a partial longitudinal length thereof, wherein a first projection extends from the first spine, and wherein a second projection extends from the second spine, wherein the first projection and the first spine define a first angle, and wherein the second projection and the second spine define a second angle.

16. The mulled window of claim 15, wherein the first and second angles are between about 15 degrees and 75 degrees.

17. The mulled window of claim 15, wherein the first and second angles are equal to each other.

18. The mulled window of claim 15, wherein the first and second spines respectively comprise first and second braces extending therefrom.

19. The mulled window of claim 18, wherein the first brace is disposed at about a 90 degree angle relative to the first spine, and wherein the second brace is disposed at about a 90 degree angle relative to the second spine.

20. The mulled window of claim 14, further comprising:
a third window comprising a third recessed mating face;
a fourth window comprising a fourth recessed mating face;
a third strip disposed in the third recessed mating face; and
a fourth strip disposed in the fourth mating face;
wherein the third and fourth strips are configured to interlock to secure the third window and the fourth window.
